(19) United States
(12) Patent Application Publication
(10) Pub. No.: US 2020/0267266 A1
(43) Pub. Date: Aug. 20, 2020

(54) IMAGE COMMUNICATION APPARATUS, IMAGE COMMUNICATION METHOD, AND NON-TRANSITORY RECORDING MEDIUM

(71) Applicant: Takashi GOTO, Kanagawa (JP)

(72) Inventor: Takashi GOTO, Kanagawa (JP)

(73) Assignee: Ricoh Company, Ltd., Tokyo (JP)

(21) Appl. No.: 16/774,404

(22) Filed: Jan. 28, 2020

(30) Foreign Application Priority Data
Feb. 15, 2019 (JP) 2019-025492

(51) Int. Cl. H04N 1/00; H04L 1/00; H04L 1/20

(52) U.S. Cl. CPC H04N 1/00214; H04L 1/203; H04L 1/0026

(57) ABSTRACT

An image communication apparatus, an image communication method, and a non-transitory recording medium. The image communication apparatus stores communication quality information related to transmission and reception of image data by the image communication apparatus after transmission and reception of the image data is completed through a communication line, stores a communication parameter, a set value related to the communication parameter, and settings related to the communication parameter, determines whether or not the communication parameter stored in the one or more memories needs to be corrected based on the communication quality information read from the one or more memories, and when correction of the communication parameter is determined necessary, correct the communication parameter requiring correction stored in the one or more memories.

### CROSS-REFERENCE TO RELATED APPLICATIONS

This patent application is based on and claims priority pursuant to 35 U.S.C. § 119(a) to Japanese Patent Application No. 2019-025492, filed on Feb. 15, 2019 in the Japan Patent Office, the entire disclosure of which is hereby incorporated by reference herein.

### BACKGROUND

### Technical Field

The present disclosure relates to an image communication apparatus, an image communication method, and a non-transitory recording medium.

### Background Art

A digital data communication control system is known, which determines whether a bit error pattern or frame error pattern occurred during communication is in a burst or random state, obtains the optimum communication condition according to the error state, and transmits the optimum communication condition to a transmission destination as a protocol signal to execute communication under the optimum communication condition.

In such a digital data communication control system, a bit error pattern/frame error pattern determination unit is provided, which recognizes patterns of digital data errors that occur on the communication transmission path for each bit or for each frame as a unit of data transmission and determines the communication status of the communication line based on the recognized patterns.

### SUMMARY

Embodiments of the present disclosure describe an image communication apparatus, an image communication method, and a non-transitory recording medium. The image communication apparatus stores communication quality information related to transmission and reception of image data by the image communication apparatus after transmission and reception of the image data is completed through a communication line, stores a communication parameter, a set value related to the communication parameter, and settings related to the communication parameter, determines whether or not the communication parameter stored in the one or more memories needs to be corrected based on the communication quality information read from the one or more memories, and when correction of the communication parameter is determined necessary, correct the communication parameter requiring correction stored in the one or more memories.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a block diagram illustrating a hardware configuration of a facsimile according to embodiments of the present disclosure;

FIG. 2 is a block diagram illustrating a functional configuration of a part of an image communication apparatus according to embodiments of the present disclosure;

FIG. 3 is a flowchart illustrating a process executed by the image communication apparatus according to embodiments of the present disclosure;

FIG. 4 is a diagram illustrating information stored in a communication quality information storage unit of the image communication apparatus according to embodiments of the present disclosure,

FIG. 5 is a diagram illustrating a history of communication quality information of the image communication apparatus according to embodiments of the present disclosure;

FIG. 6 is a diagram illustrating communication parameters and set values for correction by the image communication apparatus according to embodiments of the present disclosure;

FIG. 7 is a diagram illustrating communication quality deterioration factors referred to when a communication parameter correction unit of the image communication apparatus corrects a communication parameter according to embodiments of the present disclosure;

FIG. 8 is a diagram illustrating the communication quality deterioration factors and priority referred to when the communication parameter correction unit of the image communication apparatus corrects the communication parameter according to embodiments of the present disclosure;

FIG. 9 is a flowchart illustrating a process executed by a communication parameter correction necessity determination unit of the image communication apparatus according to embodiments of the present disclosure; and

FIG. 10 is a flowchart illustrating a process executed by the communication parameter correction unit of the image communication apparatus according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Several exemplary embodiments of the present disclosure is described hereinafter with reference to drawings.

The present disclosure has the following configuration in order to improve communication efficiency even when the line quality is poor, by minimizing repeated recoveries, communication errors and retransmissions.

Hereinafter, the features of the present disclosure is described in detail with reference to the drawings.

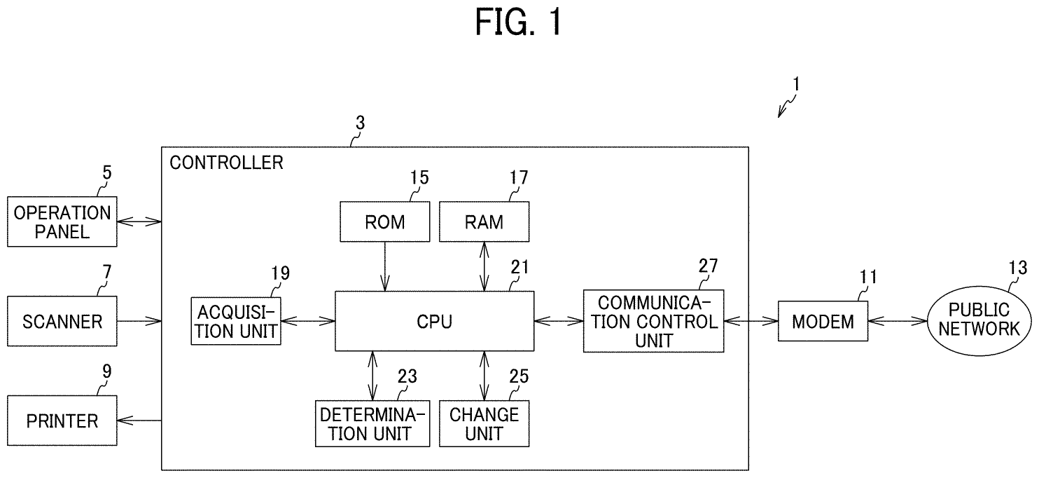

FIG. 1 is a block diagram illustrating a hardware configuration of a facsimile according to embodiments of the present disclosure.

The facsimile 1 includes a controller 3, an operation panel 5, a scanner 7, a printer 9, and a modem 11. The modem 11 is connected to the public network 13.

In order to control the entire facsimile 1, the controller 3 includes a central processing unit (CPU) 21, a read only memory (ROM) 15, and a random access memory (RAM) 17. As functions executed by the CPU 21, the controller 3 further includes an acquisition unit 19, a determination unit 23, a change unit 25, a communication control unit 27 and the like.

The ROM 15 stores a basic program of the facsimile 1, a program such as the image communication control program according to the present embodiment, system data, and the like. The RAM 17 is used as a work memory of the CPU 21.

The acquisition unit 19 acquires setting values of a plurality of setting items applied to transmission or reception of image data to or from the facsimile 1.

The determination unit 23 determines whether or not to correct the setting values of the setting items based on conditions set for each of the acquired plurality of setting items.

When it is determined that correction is needed, the change unit 25 changes the setting value of a communication quality item among the setting items to a reference value of the communication quality item.

The communication control unit 27 controls transmission and reception performed by the facsimile 1 based on the setting value of the setting item changed by the change unit 25.

Note that the functions of the acquisition unit 19, the determination unit 23, the change unit 25, and the communication control unit 27 may be implemented by hardware (such as one or more circuits) or software (such as instructions to be executed by the CPU 21).

The operation panel 5 receives an instruction to call a dialed number of the receiving terminal (that is, the facsimile to receive facsimile data) or displays operation details.

The scanner 7 scans the document to obtain a document image and encodes the document image into image data with an imaging element such as a charge coupled device (CCD) through an optical system.

The printer 9 decodes image data received from a transmission terminal (that is, a transmission source) and prints an image based on the image data on a recording paper.

The modem 11 modulates a digital signal into an analog signal and transmits the analog signal to the public network 13. The modem 11 also receives the analog signal from the public network 13 and demodulates the analog signal into the digital signal.

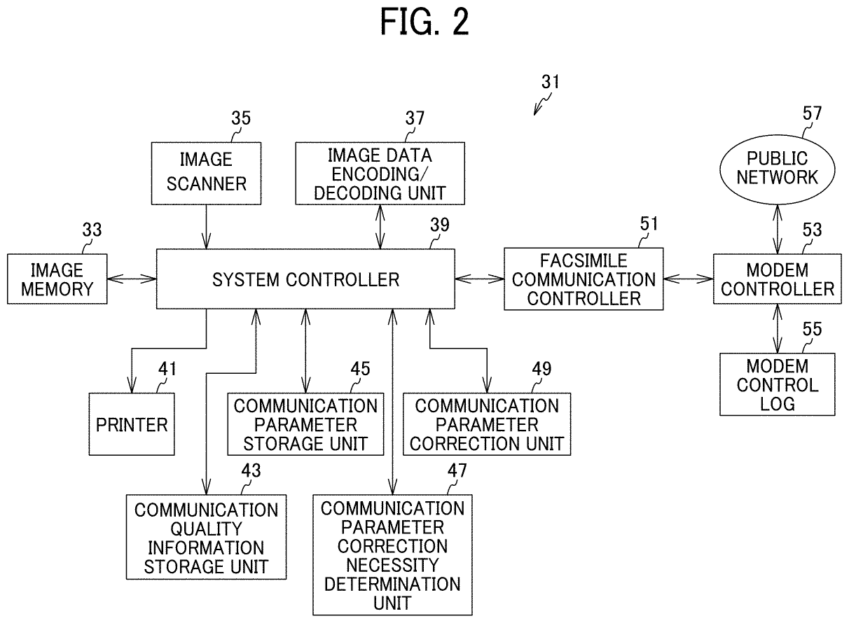

FIG. 2 is a block diagram illustrating a functional configuration of a part of an image communication apparatus according to the present embodiment. The image communication apparatus may be implemented by the facsimile 1 illustrated in FIG. 1, for example.

The image communication apparatus 31 includes an image memory 33, an image scanner 35, an image data encoding/decoding unit 37, a system controller 39, a printer 41, a communication quality information storage unit 43, a communication parameter storage unit 45, a communication parameter correction necessity determination unit 47, a communication parameter correction unit 49, a facsimile communication controller 51, a modem controller 53, and a modem control log 55. In the figure, the modem controller 53 is connected to the public network 57.

The image memory 33 develops and stores image data of a document encoded by the image data encoding/decoding unit 37 and received image data decoded by the image data encoding/decoding unit 37.

The image scanner 35 scans a document to be transmitted, performs photoelectric conversion by an imaging element such as a CCD, and outputs image data.

The image data encoding/decoding unit 37 encodes the image data read by the image scanner 35 and decodes the encoded image data received from the facsimile communication controller 51.

The system controller 39 includes a processor, a ROM, a RAM, a nonvolatile memory, and the like in order to control the entire image communication apparatus 31. The ROM stores a basic program of the image communication apparatus 31, a program such as the image communication control program of the present disclosure, system data, and the like, and the RAM is used as a work memory of the processor.

For example, a nonvolatile random access memory (NVRAM) or the like is used as the nonvolatile memory. The nonvolatile memory stores data that needs to be kept stored even when the power of the image communication apparatus 31 is OFF. In particular, the nonvolatile memory stores various data used in the image communication control process of the present disclosure.

The processor includes a CPU or the like. The processor uses the RAM as a work memory based on a program in the ROM, controls each unit of the image communication apparatus 31, executes basic processing as the image communication apparatus 31, and performs image communication control of the present disclosure.

The image communication control program is recorded on a computer-readable recording medium such as a ROM, an Electrically Erasable and Programmable Read Only Memory (EEPROM), an Erasable and Programmable Read Only Memory (EPROM), a flash memory, a flexible disk, a Compact Disc Read Only Memory (CDROM), a Compact Disc Rewritable (CD-RW), a Digital Versatile Disk (DVD), a Secure Digital (SD) card, a Magneto-Optical (MO) Disc and the like.

The image communication control program for executing an image communication control method of the present disclosure is read and loaded into a ROM or the like of the system controller 39, to cause the image communication apparatus 31 to execute the image communication control method described below. The image communication control program is a computer-executable program written in a legacy programming language such as an assembler, C, C++, C #, Java (registered trademark), an object-oriented programming language, or the like, and can be stored in the recording medium described above for distribution.

Each function of the embodiment described above can be implemented by one or a plurality of processing circuitry. Processing circuitry includes a programmed processor, as a processor includes circuitry. A processing circuitry also includes devices such as an application specific integrated circuit (ASIC), digital signal processor (DSP), field programmable gate array (FPGA), and conventional circuit components arranged to perform the recited functions.

The printer 41 prints an image on recording paper based on image data deployed in the image memory 33 from the image data decoded by the image data encoding/decoding unit 37.

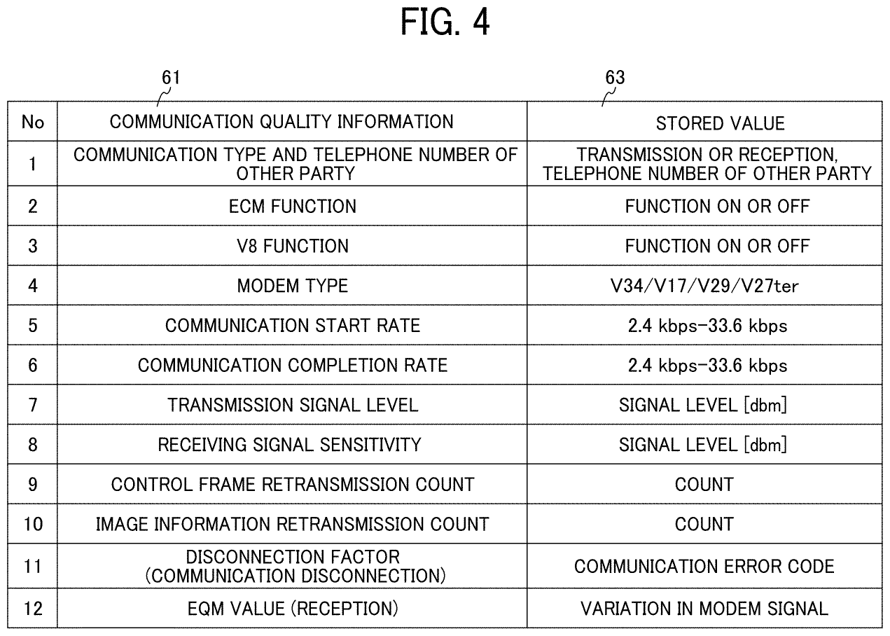

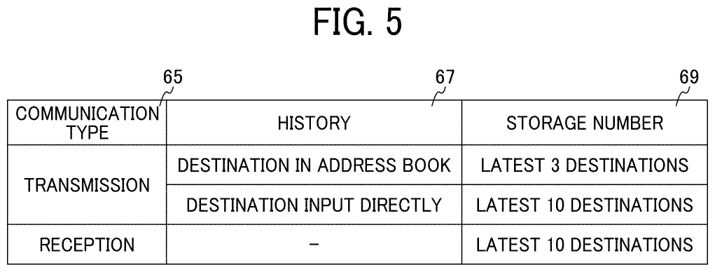

The communication quality information storage unit 43 stores latest communication quality information 61 (FIG. 4) after transmission or reception operation by the image communication apparatus 31 is completed. At the same time, a history of communication quality information is also stored (FIG. 5).

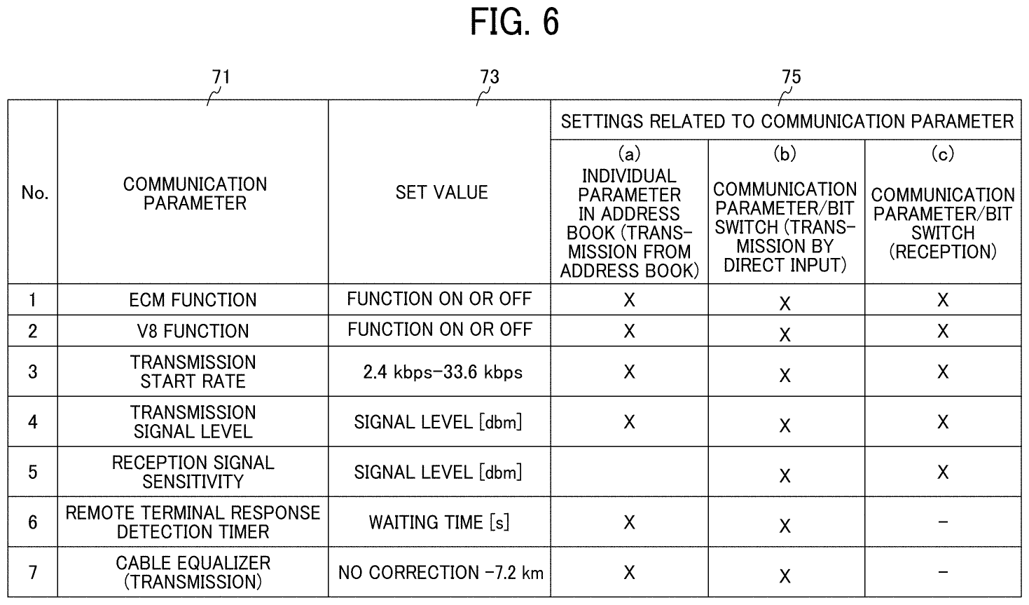

The communication parameter storage unit 45 stores a communication parameter 71, a set value 73 related to the communication parameter 71, and settings 75 related to the communication parameter 71 (FIG. 6).

The communication quality information storage unit 43 and the communication parameter storage unit 45 may be implemented by any desired one or more memories in the image communication apparatus, such as the RAM 17 of FIG. 1.

The communication parameter correction necessity determination unit 47 determines whether the communication parameter stored in the communication parameter storage unit 45 needs to be corrected based on the communication quality information read from the communication quality information storage unit 43.

The communication parameter correction unit 49 corrects the communication parameter that needs to be corrected when the communication parameter correction necessity determination unit 47 executes communication quality diagnosis and determines that the communication parameter needs to be corrected. The corrected communication parameter is stored in the communication parameter storage unit 45.

The facsimile communication controller 51 transmits the image data to be transmitted that is stored in the image memory 33 using the communication parameter stored in the communication parameter storage unit 45, decodes the received image data, and stores the decoded image data in the image memory 33.

The modem controller 53 modulates a digital signal into an analog signal and transmits the analog signal to the public network 57. The modem controller 53 also receives the analog signal from the public network 57 and demodulates the analog signal into the digital signal.

The modem control log 55 stores errors detected by the modem controller 53 in the decoding process of the modem signal from the transmission side.

The public network 57 generally indicates the internet or a telephone line.

Next, operation of the image communication apparatus 31 is described. Here, the image communication apparatus 31 is described as an image communication apparatus having a facsimile function.

1) First, a telephone number of a destination is input, a document is read by the image scanner 35, image data is temporarily deployed in the image memory 33, the image data is encoded by the image data encoding/decoding unit 37, and then stored in the image memory 33.

2) When a dial signal is transmitted, a CNG signal is transmitted from a transmission side to a reception side.

3) When the line is connected, the reception side detects the CNG signal from the transmission side, activates the facsimile communication controller 51, and issues a CED signal as a response.

4) The transmission and reception sides exchange capability information implemented on the transmission and reception sides, determine the maximum available communication speed, image data encoding and code correction method, etc., and adjust modems by training.

5) The facsimile communication controller 51 uses the communication parameters stored in the communication parameter storage unit 45 to transmit the image data stored in the image memory 33 to the reception side through the modem controller 53. The transmission side transmits the image data one after another while confirming reception completion signals from the facsimile on the reception side. When an error is detected, image data is re-transmitted.

6) The line is disconnected when transmission ends or when there is no response from the other side for a certain period of time.

7) After the facsimile communication is completed, latest communication quality information is stored in the communication quality information storage unit 43 illustrated in FIG. 2.

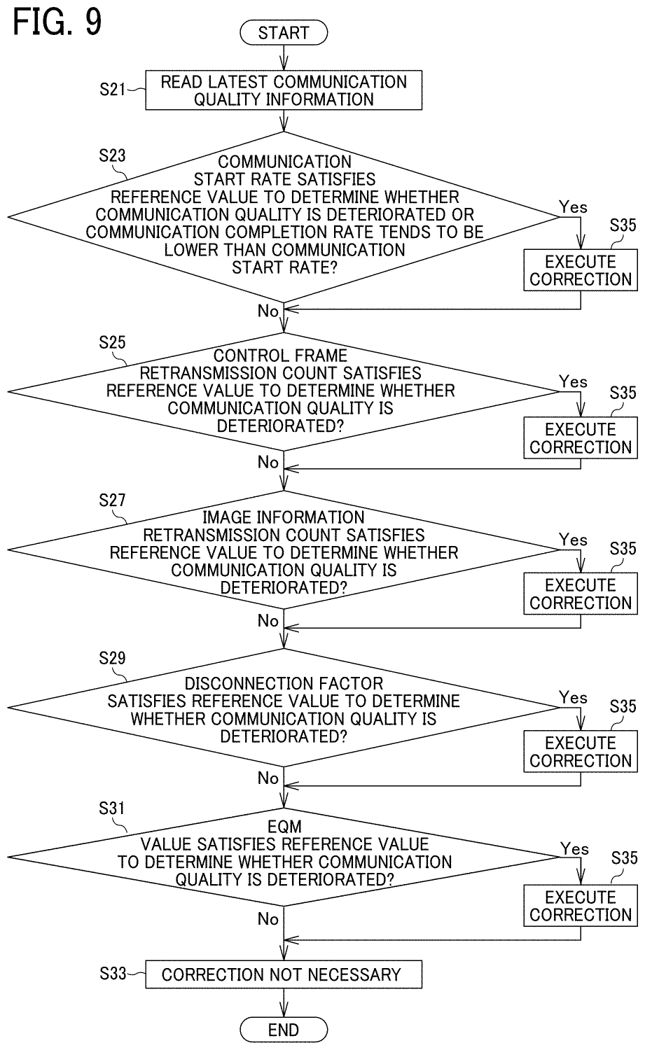

8) The communication parameter correction necessity determination unit 47 executes the communication quality diagnosis for next communication, based on the communication quality information stored in the communication quality information storage unit 43 according to a flowchart illustrated in FIG. 9.

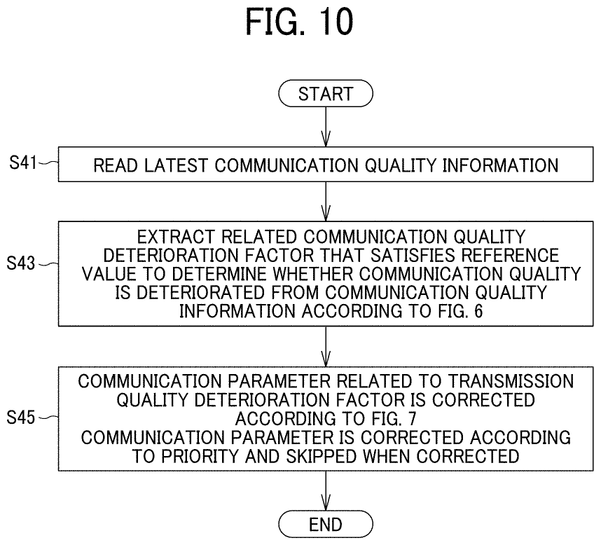

9) The communication parameter correction unit 49 updates the communication parameter storage unit 45 by executing communication parameter correction according to the process described in the flowchart illustrated in FIG. 10, when it is determined that communication parameter correction is necessary, as a result of executing the communication quality diagnosis. On the other hand, when it is determined that communication parameter correction is not necessary as a result of the communication quality diagnosis, the process ends without further operation.

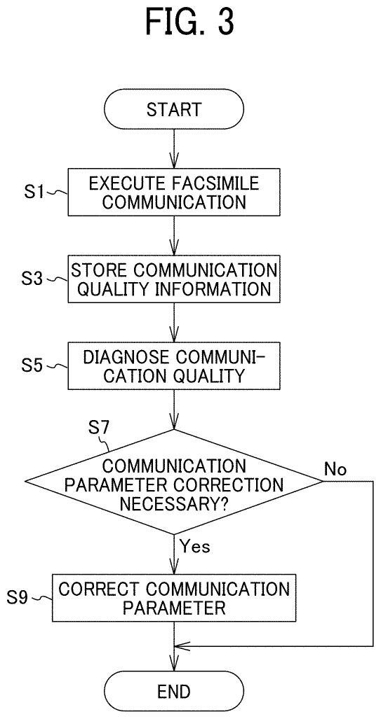

FIG. 3 is a flowchart illustrating a process executed by the image communication apparatus according to the present embodiment.

In step S1, normal facsimile communication is executed. For example, the transmission and reception of image data is executed as described below.

1) A telephone number of other party is input, and a document is stored in a memory as image data.

2) When a dial signal is transmitted, a CNG signal is transmitted from a transmission side to a reception side.

3) When the line is connected, the reception side detects the CNG signal from the transmission side, activates the facsimile, and responds with a CED signal.

4) The transmission and reception sides exchange capability information implemented on the transmission and reception sides, determine the maximum available communication speed, image data encoding and code correction method, etc., and adjust modems by training.

5) Data is transmitted from the transmission side in an image signal format adapted to the system.

While confirming reception completion signals from the facsimile on the reception side, the transmission side transmits data one after another. When an error is detected, the image data is re-transmitted.

6) The line is disconnected when transmission ends or when there is no response from the other side for a certain period of time.

After the facsimile communication is completed in step S1, latest communication quality information (FIG. 4) is stored in the communication quality information storage unit 43 illustrated in FIG. 2 in step S3.

In step S5, based on the communication quality information (FIG. 4) stored in the communication quality information storage unit 43, the communication quality diagnosis is performed according to the process described in a flowchart illustrated in FIG. 9.

If it is determined in step S7 that the communication parameter needs to be corrected as a result of the communication quality diagnosis (Yes in step S7), the process proceeds to step S9. On the other hand, if it is determined that the correction of the communication parameter is not necessary (No in step S7) as a result of the communication quality diagnosis, the process ends without further operation.

In step S9, the communication parameter is corrected according to a flowchart illustrated in FIG. 10.

FIG. 4 is a diagram illustrating information stored in the communication quality information storage unit of the image communication apparatus according to the present embodiment.

The communication quality information storage unit 43 stores communication quality information 61 and a set value (contents of communication quality information) 63. In row No. 1, whether facsimile communication is a transmission (TX) or a reception (RX) and a telephone number of other party are stored.

In row No. 2, whether error correction mode (ECM) function was on or off is stored. ECM is a type of G3 communication used between facsimiles having ECM mode. When communication is performed in the ECM mode, whether data is correctly sent to the other party is checked, and communication is performed while confirming that there is no error. When data is not sent correctly due to the error or the like, the data is retransmitted.

In row No. 3, whether V8 function was on or off is stored.

In row No. 4, a modem type used in the communication is selected from V34, V17, V29, or V27ter and stored.

In row No. 5, a communication start rate within the range of 2.4 kbps to 33.6 kbps is selected and stored.

In row No. 6, a communication completion rate within a range of 2.4 kbps to 33.6 kbps is selected and stored.

In row No. 7, a transmission signal level is stored in decibel milliwatt (dbm).

In row No. 8, receiving signal sensitivity is stored in dbm.

In row No. 9, a control frame retransmission count is stored in count value.

In row No. 10, an image information retransmission count is stored in count value.

In row No. 11, a disconnection factor (at the time of communication disconnection) is stored by communication error code when communication is disconnected.

In row No. 12, an equalizer quality monitor (EQM) value (during reception) in value indicating variation in modem signal is stored.

Of the communication quality information described above, information other than information stored in row No. 1 is used for determining necessity of communication parameter correction. The communication quality information described above is stored in the communication quality information storage unit 43 in FIG. 2.

FIG. 5 is a diagram illustrating a history of communication quality information of the image communication apparatus according to the present embodiment.

In the example illustrated in FIG. 5, a communication type 65, a history 67, and a storage number 69 are stored, and the communication type 65 includes transmission and reception. The storage number 69 for transmissions to destinations registered in the address book in advance indicates that latest 3 destinations are stored.

The storage number 69 for transmissions to destinations input directly indicates that latest 10 destinations are stored.

The storage number 69 for receptions indicates that latest 10 destinations are stored.

The history of communication quality information described above is stored in the communication quality information storage unit 43 illustrated in FIG. 2.

FIG. 6 is a diagram illustrating communication parameter to be corrected and value to be set by the image communication apparatus according to embodiments of the present disclosure.

The communication parameter storage unit 45 stores a communication parameter 71, a set value 73, and settings related to communication parameter 75. The settings related to communication parameter 75 includes (a) individual parameter in address book (for transmissions from address book), (b) communication parameter/bit switch (for transmissions by direct input), and (c) communication parameter/bit switch (for receptions). In FIG. 6, an “X” indicates settings applicable to each communication parameter.

In the example illustrated in FIG. 6, row No. 1 stores “ECM function” as one of the communication parameters, “ECM function on or off” as the set value, and that all settings (a) to (c) are related to the ECM function.

Row No. 2 stores “V8 function” as one of the communication parameters, “V8 function on or off” as the set value, and that all settings (a) to (c) are related to the V8 function.

Row No. 3 stores “transmission start rate” as one of the communication parameters, “2.4 kbps to 33.6 kbps” as a range of set value, and that all settings (a) to (c) are related to the transmission start rate.

Row No. 4 stores “transmission signal level” as one of the communication parameters, “signal level in dbm” as the set value, and that all settings (a) to (c) are related to the transmission signal level.

Row No. 5 stores “reception signal sensitivity” as one of the communication parameters, “signal level in dbm” as the set value, and that all settings (b) and (c) are related to the reception signal sensitivity.

Row No. 6 stores “remote terminal response detection timer” as one of the communication parameters, “waiting time in seconds” as the set value, and that settings (a) and (b) are related to the remote terminal response detection timer.

Row No. 7 stores “cable equalizer” as one of the communication parameters, “no correction to 7.2 km” as a range of set value, and that settings (a) and (b) are related to the cable equalizer.

The communication parameters No. 6 and No. 7 are items corresponding to “transmission” of the communication type 65 illustrated in FIG. 5. The information described above is stored in the communication parameter storage unit 45 illustrated in FIG. 2.

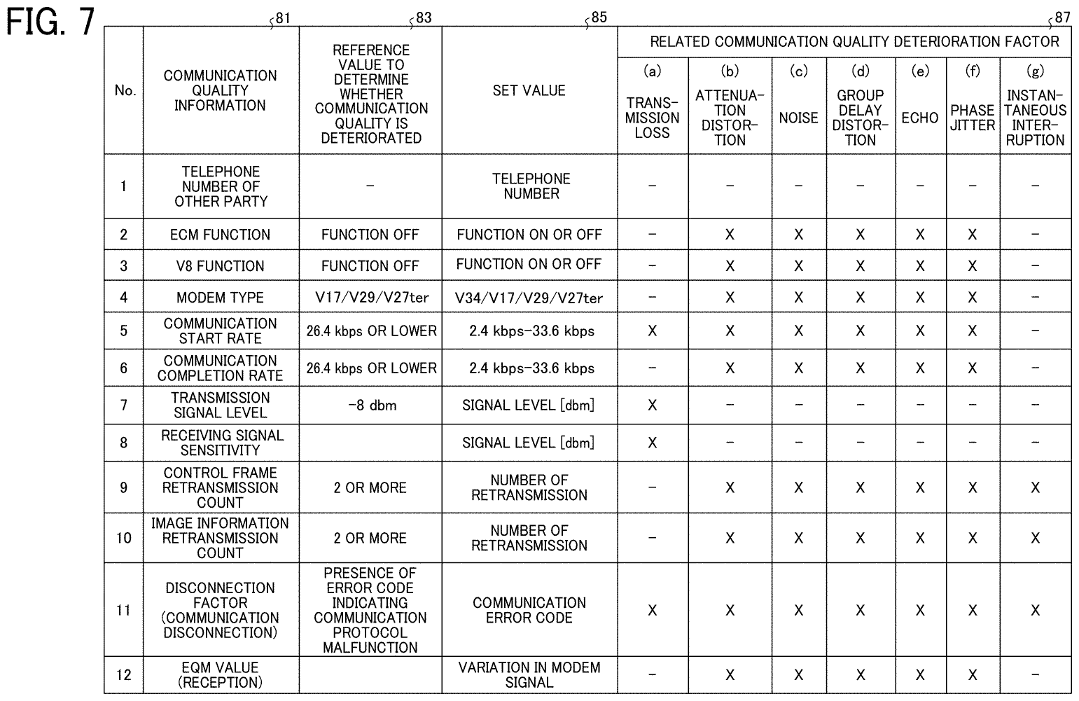

FIG. 7 is a diagram illustrating communication quality deterioration factors referred to when the communication parameter correction unit of the image communication apparatus corrects the communication parameter according to embodiments of the present disclosure.

As illustrated in FIG. 7, the communication quality information storage unit 43 stores a communication quality information 81, a reference value to determine whether communication quality is deteriorated 83, a set value 85, and a related communication quality deterioration factor 87. The related communication quality deterioration factor 87 includes transmission loss (a), attenuation distortion (b), noise (c), group delay distortion (d), echo (e), phase jitter (f), and instantaneous interruption (g). In FIG. 7, an “X” indicates settings applicable to each communication parameter.

In the example illustrated in FIG. 7, in row No. 1, “telephone number of other party” is stored and none of the communication quality deterioration factor is applicable.

In row No. 2, “ECM function” is stored as the communication quality information 81, “function off” is stored as the reference value to determine whether communication quality is deteriorated 83, and “function on or off” is selected and stored as the set value 85. The related communication quality deterioration factor 87 stores that the communication quality deterioration factors (b) to (f) are applicable.

In row No. 3, “V8 function” is stored as the communication quality information 81, “function off” is stored as the reference value to determine whether communication quality is deteriorated 83, and “function on or off” is selected and stored as the set value 85. The related communication quality deterioration factor 87 stores that the communication quality deterioration factors (b) to (f) are applicable.

In row No. 4, “modem type” is stored as the communication quality information 81, “V17, V29, or V27ter” is stored as the reference value to determine whether communication quality is deteriorated 83, and one of “V34, V17, V29, or V27ter” is selected and stored as the set value 85. The related communication quality deterioration factor 87 stores that the communication quality deterioration factors (b) to (f) are applicable.

In row No. 5, “communication start rate” is stored as the communication quality information 81, “26.4 kbps or lower” is stored as the reference value to determine whether communication quality is deteriorated 83, and a value within “2.4 kbps to 33.6 kbps” is selected and stored as the set value 85. The related communication quality deterioration factor 87 stores that the communication quality deterioration factors (a) to (f) are applicable.

In row No. 6, “communication completion rate” is stored as the communication quality information 81, “26.4 kbps or lower” is stored as the reference value to determine whether communication quality is deteriorated 83, and a value within “2.4 kbps to 33.6 kbps” is selected and stored as the set value 85. The related communication quality deterioration factor 87 stores that the communication quality deterioration factors (b) to (f) are applicable.

In row No. 7, “transmission signal level” is stored as the communication quality information 81, “−8 dbm” is stored as the reference value to determine whether communication quality is deteriorated 83, and “signal level in dbm” is stored as the set value 85. The related communication quality deterioration factor 87 stores that the communication quality deterioration factor (a) is applicable.

In row No. 8, “receiving signal sensitivity” is stored as the communication quality information 81 and “signal level in dbm” is stored as the set value 85. The related communication quality deterioration factor 87 stores that the communication quality deterioration factor (a) is applicable.

In row No. 9, “control frame retransmission count” is stored as the communication quality information 81, “2 or more” is stored as the reference value to determine whether communication quality is deteriorated 83, and number of retransmission is stored as the set value 85. The related communication quality deterioration factor 87 stores that the communication quality deterioration factors (b) to (g) are applicable.

In row No. 10, “image information retransmission count” is stored as the communication quality information 81, “2 or more” is stored as the reference value to determine whether communication quality is deteriorated 83, and number of retransmission is stored as the set value 85. The related communication quality deterioration factor 87 stores that the communication quality deterioration factors (b) to (g) are applicable.

In row No. 11, “disconnection factor (for communication disconnection)” is stored as the communication quality information 81, “presence of error code indicating communication protocol malfunction” is stored as the reference value to determine whether communication quality is deteriorated 83, and “communication error code” is stored as the set value 85. The related communication quality deterioration factor 87 stores that the communication quality deterioration factors (a) to (g) are applicable.

In row No. 12, “EQM value (reception)” is stored as the communication quality information 81 and “variation in modem signal” is stored as the set value 85. The related communication quality deterioration factor 87 stores that the communication quality deterioration factors (b) to (f) are applicable.

The information described above is stored in the communication quality information storage unit 43 illustrated in FIG. 2.

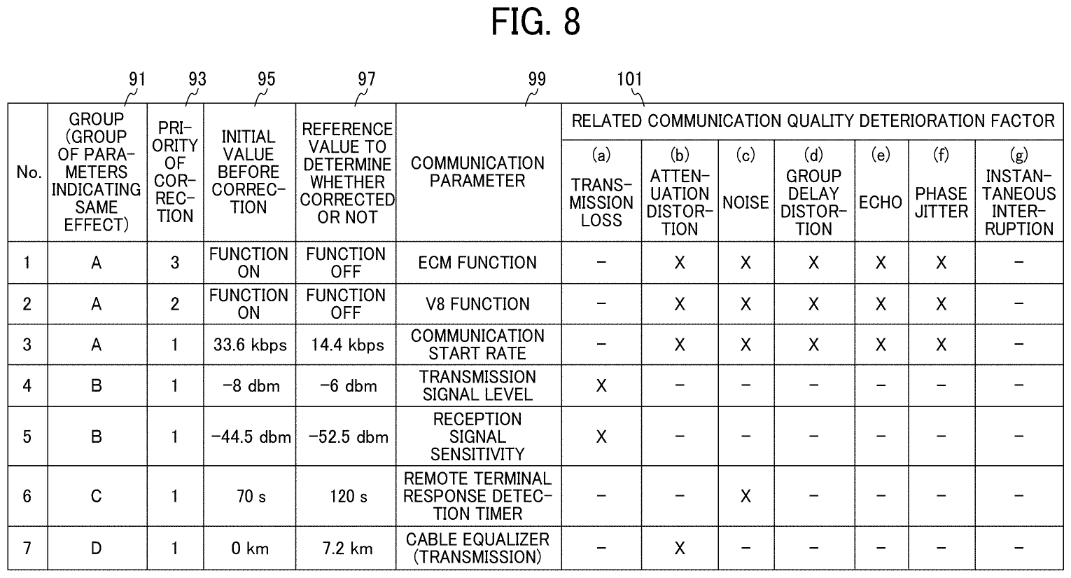

FIG. 8 is a diagram illustrating the communication quality deterioration factors and priority of correction referred to when the communication parameter correction unit of the image communication apparatus corrects the communication parameter according to embodiments of the present disclosure.

In the communication parameter storage unit 45, a group (parameters indicating the same effect are categorized into the same group) 91, priority of correction 93, an initial value before correction 95, a reference value to determine whether the communication parameter is corrected or not 97, a communication parameter 99, and a related communication quality deterioration factor 101 are stored. The related communication quality deterioration factor 101 includes transmission loss (a), attenuation distortion (b), noise (c), group delay distortion (d), echo (e), phase jitter (f) and instantaneous interruption (g). In FIG. 8, an “X” indicates settings applicable to each communication parameter.

In the example illustrated in FIG. 8, for the communication parameter 99 “ECM function” stored in row No. 1, the group 91 is “A”, the priority of correction 93 is “3”, the initial value before correction 95 is “function on”, the reference value to determine whether the communication parameter is corrected or not 97 is “function off”, and the related communication quality deterioration factors 101 (b) to (f) are applicable.

For the communication parameter 99 “V8 function” stored in row No. 2, the group 91 is “A”, the priority of correction 93 is “2”, the initial value before correction 95 is “function on”, the reference value to determine whether the communication parameter is corrected or not 97 is “function off”, and the related communication quality deterioration factors 101 (b) to (f) are applicable.

For the communication parameter 99 “communication start rate” stored in row No. 3, the group 91 is “A”, the priority of correction 93 is “1”, the initial value before correction 95 is “33.6 kbps”, the reference value to determine whether the communication parameter is corrected or not 97 is “14.4 kbps”, and the related communication quality deterioration factors 101 (b) to (f) are applicable.

For the communication parameter 99 “transmission signal level” stored in row No. 4, the group 91 is “B”, the priority of correction 93 is “1”, the initial value before correction 95 is “−8 dbm”, the reference value to determine whether the communication parameter is corrected or not 97 is “−6 dbm”, and the related communication quality deterioration factor 101 (a) is applicable.

For the communication parameter 99 “receiving signal sensitivity” stored in row No. 5, the group 91 is “B”, the priority of correction 93 is “1”, the initial value before correction 95 is “−44.5 dbm”, the reference value to determine whether the communication parameter is corrected or not 97 is “−52.5 dbm”, and the related communication quality deterioration factor 101 (a) is applicable.

For the communication parameter 99 “remote terminal response detection timer” stored in row No. 6, the group 91 is “C”, the priority of correction 93 is “l”, the initial value before correction 95 is “70 seconds”, the reference value to determine whether the communication parameter is corrected or not 97 is “120 seconds”, and the related communication quality deterioration factor 101 (c) is applicable.

For the communication parameter 99 “cable equalizer (transmission)” stored in row No. 7, the group 91 is “D”, the priority of correction 93 is “l”, the initial value before correction 95 is “0 km”, the reference value to determine whether the communication parameter is corrected or not 97 is “7.2 km”, and the related communication quality deterioration factor 101 (b) is applicable.

The initial value before correction 95 is indicated as a specific value of the set value 73 in FIG. 6.

FIG. 9 is a flowchart illustrating a process executed by the communication parameter correction necessity determination unit of the image communication apparatus according to embodiments of the present disclosure. In the below description, FIGS. 4 to 8 are also referred to.

In step S21, the latest communication quality information is read from the communication quality information storage unit 43 illustrated in FIG. 2.

In step S23, whether the communication start rate satisfies the reference value to determine whether the communication quality is deteriorated “26.4 kbps or lower”, or whether the communication completion rate tends to be lower than the communication start rate is determined. If at least one of conditions is satisfied (Yes in step S23), the process proceeds to step S35 and the correction is executed. On the other hand, if none of the conditions is satisfied in step S23, the process proceeds to step S25.

In step S25, whether the number of control frame retransmission count satisfies the reference value to determine whether the communication quality is deteriorated “2 or more” is determined. If the reference value to determine whether the communication quality is deteriorated is satisfied (Yes in step S25), the process proceeds to step S35 and the correction is executed. On the other hand, if the reference value to determine whether the communication quality is deteriorated is not satisfied in step S25, the process proceeds to step S27.

In step S27, whether the number of image information retransmission count satisfies the reference value to determine whether the communication quality is deteriorated “2 or more” is determined. If the reference value to determine whether the communication quality is deteriorated is satisfied (Yes in step S27), the process proceeds to step S35 and correction is executed. On the other hand, if the reference value to determine whether the communication quality is deteriorated is not satisfied in step S27, the process proceeds to step S29.

In step S29, whether the disconnection factor satisfies the reference value to determine whether the communication quality is deteriorated “presence of error code indicating communication protocol malfunction” is determined. If the reference value to determine whether the communication quality is deteriorated is satisfied (Yes in step S29), the process proceeds to step S35 and the correction is executed. On the other hand, if the reference value to determine whether the communication quality is deteriorated is not satisfied in step S29, the process proceeds to step S31.

In step S31, whether the EQM value satisfies the reference value to determine whether the communication quality is deteriorated is determined. If the reference value to determine whether the communication quality is deteriorated is satisfied (Yes in step S31), the process proceeds to step S35 and the correction is executed. On the other hand, if the reference value to determine whether the communication quality is deteriorated is not satisfied in step S31, the process proceeds to step S33 and no correction is executed.

FIG. 10 is a flowchart illustrating a process executed by the communication parameter correction unit of the image communication apparatus according to embodiments of the present disclosure.

In step S41, the latest communication quality information is read from the communication quality information storage unit 43 illustrated in FIG. 2.

In step S43, all related communication quality deterioration factors are extracted from the communication quality information that satisfies the reference value to determine that the communication quality is deteriorated according to FIG. 6.

In step S45, the communication parameter related to the communication quality deterioration factor is corrected according to FIG. 7. At this time, the communication parameter to be corrected is selected according to the priority for each group, but when the communication parameter has been corrected already, a communication parameter of next priority is corrected.

The image communication apparatus 31 according to embodiments of the present disclosure includes the communication quality information storage unit 43 (an example of a first memory) for storing the communication quality information related to the transmission and reception, after transmission and reception of image data through the communication line is completed, the communication parameter storage unit 45 (an example of a second memory) for storing the communication parameter 71, the set value 73 related to the communication parameter 71, and the settings 75 related to the communication parameter 71, the communication parameter correction necessity determination unit 47 for determining whether or not the communication parameter 71 stored in the communication parameter storage unit 45 needs to be corrected based on the communication quality information 61 read from the communication quality information storage unit 43, and the communication parameter correction unit 49 for correcting the communication parameter 71 that needs correction and stores the communication parameter in the communication parameter storage unit 45 when the communication parameter correction necessity determination unit 47 determines that the correction is necessary.

The system controller 39 according to embodiments of the present disclosure stores the latest communication quality information in the communication quality information storage unit 43 after the transmission and reception of the image data through the communication line is completed, generates communication parameter 71 based on the communication quality information 61, stores the communication parameter 71 in the communication parameter storage unit 45, causes the communication parameter correction necessity determination unit 47 to determine whether or not correction is necessary from the stored communication parameter 71 based on the reference value, causes the communication parameter correction unit 49 to correct the communication parameter 71 determined to be corrected, and updates the communication parameter storage unit 45.

With the above operation, it is possible to improve the communication efficiency by minimizing the repetition of recovery during communication, communication errors, and retransmissions even when the channel quality is poor.

The communication parameter correction necessity determination unit 47 determines whether the communication parameter 71 needs to be corrected based on the communication quality information selected from the communication quality information 61 stored in the communication quality information storage unit 43.

According to the embodiments of the present disclosure, the necessity of correction is determined based on the selected communication quality information that has a particular influence on the communication quality from the communication quality information 61.

As a result, it is possible to determine whether or not correction is necessary only for selected communication quality information, resulting in improving the efficiency of the determination process.

The selected communication quality information is at least one of the modem type, the communication start rate, the communication completion rate, the control frame retransmission count, the image information retransmission count, the disconnection factor, and the EQM value.

According to the embodiments of the present disclosure, since the selected communication quality information is at least one of the plurality of pieces of communication quality information, the communication parameter 71 can be determined only by information related to the communication quality.

The communication parameter correction necessity determination unit 47 sets a reference value to determine whether communication quality is deteriorated 83 for the selected communication quality information and determines that the communication parameter 71 needs correction when the reference value to determine whether communication quality is deteriorated 83 is not satisfied.

According to the embodiments of the present disclosure, the reference value to determine whether communication quality is deteriorated 83 is set for the selected communication quality information, and the necessity of determination of correction is determined based on the reference value to determine whether communication quality is deteriorated 83.

As a result, communication quality can be kept constant.

When the communication parameter correction necessity determination unit 47 determines that correction is necessary, the communication parameter correction unit 49 extracts the communication quality deterioration factor 87 from the communication quality information stored in the communication quality information storage unit 43 and corrects the communication parameter 99 related to the extracted communication quality deterioration factor 87.

According to the embodiments of the present disclosure, the communication parameter correction unit 49 extracts and corrects the communication quality deterioration factor 87 from the communication parameter determined to be corrected.

As a result, the reliability of correction can be improved.

The communication parameter correction unit 49 categorizes the communication parameter 99 having the same communication quality deterioration factor into the group 91 and selects and corrects the corresponding communication parameter 99 according to the priority of correction 93 for each group.

According to the embodiments of the present disclosure, communication parameters having the same communication quality deterioration factor are grouped, and the priority is set and corrected in the group.

As a result, correction can be made efficiently based on the priority.

An image communication method according to the embodiments of the present disclosure executed by the image communication apparatus including the communication quality information storage unit 43 (an example of the first memory) for storing the communication quality information related to the transmission and reception, after the transmission and reception of the image data through the communication line is completed and the communication parameter storage unit 45 (an example of the second memory) for storing the communication parameter 71, the set value 73 related to the communication parameter 71, and the settings 75 related to the communication parameter 71, includes determining whether or not the communication parameter 71 stored in the communication parameter storage unit 45 needs to be corrected, based on the communication quality information 61 read from the communication quality information storage unit 43, correcting the communication parameter 71 that needs to be corrected and storing the corrected communication parameter 71 in the communication parameter storage unit 45, when correction of the communication parameter is determined necessary.

The system controller 39 according to the embodiments of the present disclosure stores the latest communication quality information in the communication quality information storage unit 43 after the transmission and reception of the image data through the communication line is completed, generates communication parameter 71 based on the communication quality information 61, stores the communication parameter 71 in the communication parameter storage unit 45, causes the communication parameter correction necessity determination unit 47 to determine whether or not correction is necessary from the stored communication parameter 71 based on the reference value, causes the communication parameter correction unit 49 to correct the communication parameter 71 determined to be corrected, and updates the communication parameter storage unit 45.

With the process described above, it is possible to improve the communication efficiency by minimizing the repetition of recovery, communication errors, and retransmissions even when the channel quality is poor.

According to the embodiments of the present disclosure, each step described above can be executed by one or more processors. For this reason, even when the line quality is poor, it is possible to improve the communication efficiency by minimizing the repetition of recovery, communication errors, and retransmissions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. A communication apparatus comprising:
one or more memories that:
store communication quality information related to transmission and reception of image data by the image communication apparatus after transmission and reception of the image data is completed through a communication line; and
store a communication parameter, a set value related to the communication parameter, and settings related to the communication parameter; and
circuitry configured to:
determine whether or not the communication parameter stored in the one or more memories needs to be corrected based on the communication quality information read from the one or more memories; and
when correction of the communication parameter is determined necessary, correct the communication parameter requiring correction stored in the one or more memories.

2. The image communication apparatus of claim 1, wherein
the circuitry determines whether or not the communication parameter needs to be corrected based on the communication quality information selected from the communication quality information stored in the one or more memories.

3. The image communication apparatus of claim 2, wherein
the selected communication quality information is at least one of modem type, communication start rate, communication completion rate, control frame retransmission count, image information retransmission count, disconnection factor, and EQM value.

4. The image communication apparatus of claim 2, wherein
a reference value is set for each of the selected communication quality information, and the correction of the communication parameter is determined necessary when the reference value is not satisfied.

5. The image communication apparatus of claim 1, wherein
when the correction of the communication parameter is determined necessary, the circuitry is further configured to:
extract communication quality deterioration factor from the communication quality information; and
correct the communication parameter related to the extracted communication quality deterioration factor.

6. The image communication apparatus of claim 5, wherein
the communication parameter includes a plurality of communication parameters having the same communication quality deterioration factor, which are formed into a group, and
the related communication parameter is selected and corrected according to priority of each group.

7. An image communication method executed by an image communication apparatus, the method comprising:
storing, in one or more memories, communication quality information related to transmission and reception of image data by the image communication apparatus, after transmission and reception of the image data through a communication line is completed;
storing, in the one or more memories, a communication parameter, a set value related to the communication parameter, and settings related to the communication parameter;
determining whether or not correcting the communication parameter stored in the one or more memories is necessary based on the communication quality information read from the one or more memories; and
correcting the communication parameter that needs correction stored in the one or more memories, when the determining determines that the correction of the communication parameter is necessary.

8. A machine-readable, non-transitory recording medium storing instructions which, when executed by one or more processors, cause the one or more processors to perform an image communication method comprising:
storing, in one or more memories, communication quality information related to transmission and reception of image data by the image communication apparatus, after transmission and reception of the image data through a communication line is completed;
storing, in the one or more memories, a communication parameter, a set value related to the communication parameter, and settings related to the communication parameter;
determining whether or not correcting the communication parameter stored in the one or more memories is necessary based on the communication quality information read from the one or more memories; and
correcting the communication parameter that needs correction stored in the one or more memories, when the determining determines that the correction of the communication parameter is necessary.
